(19) United States
(12) Patent Application Publication
(10) Pub. No.: US 2026/0211642 A1
(43) Pub. Date: Jul. 23, 2026

(54) MANAGING A SET OF CHANGES FOR A CODEBASE BY ITERATIVELY EVALUATING THE SET OF CHANGES

(71) Applicant: Dell Products L.P., Round Rock, TX (US)

(72) Inventors: BORIS SHPILYUCK, Ashdod (IL); YONIT LOPATINSKI, Shomria (IL); OR HERMAN SAFFAR, Ofakim (IL); JEHUDA SHEMER, Kfar Saba (IL)

(21) Appl. No.: 19/033,004

(22) Filed: Jan. 21, 2025

(51) Int. Cl. G06F 8/36; G06F 8/34

(52) U.S. Cl. CPC G06F 8/36; G06F 8/34

(57) ABSTRACT

Methods and systems for providing computer-implemented services using a data processing system are disclosed. To provide the computer-implemented services, a dynamically generated set of changes for a codebase including source code for a software program may be iteratively evaluated until a final set of changes meeting change criteria is obtained. The change criteria may be adapted to discriminate whether the final set of changes is likely to introduce undesired operation of an updated version of the software program. Using the final set of changes, an integration process may be performed to obtain the updated version of the software program to continue provision of the computer-implemented services.

### FIELD

Embodiments disclosed herein relate generally to managing a set of changes for a codebase. More particularly, embodiments disclosed herein relate to systems and methods to manage a set of changes for a codebase by iteratively evaluating the set of changes.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIGS. 3A-3C show flow diagrams illustrating a method for providing computer-implemented services in accordance with an embodiment.

FIG. 4 shows a diagram illustrating an example implementation in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using a data processing system. The data processing system may be used by a business, individual, and/or any other downstream consumer of the computer-implemented services. To provide the computer-implemented services to the downstream consumer, the data processing system may include any number of hardware components, such as processors, memory modules, storage devices, communication devices, etc. The hardware components of the data processing system may support execution of any number and/or type of software components (e.g., software programs). Changes in available functionalities of the hardware components and/or the software components of the data processing system may provide for various types of different computer-implemented services to be provided to the downstream consumer.

Over time, the software components of the data processing system may be modified. For example, a software program hosted by the data processing system may be updated to improve performance of the data processing system, add functionality to the data processing system, reduce a security risk associated with the software program, etc. Updates and/or other modifications made to the software components of the data processing system may allow for additional computer-implemented services to be provided, more reliable computer-implemented services to be provided, the computer-implemented services to be provided in a more secure manner, and/or other improvements to the computer-implemented services provided to the downstream consumer.

The software components of the data processing system may be modified by integrating a set of changes to source code for a software program into a codebase. However, integrating the set of changes into the codebase may have undesired impacts on the software program. For example, the set of changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumer using the software program may be delayed, provided in a manner that does not meet the expectations of the downstream consumer, and/or may otherwise be negatively impacted.

To reduce a likelihood of errors being introduced into the codebase and/or other undesired impacts on the functionality of the software program, a dynamically generated set of changes for a codebase (e.g., a provisional set of changes obtained during a process of generating a final set of changes by an entity) may be iteratively evaluated until a final set of changes meeting change criteria is obtained (e.g., from the entity through a graphical user interface (GUI)). The final set of changes may include changes to the source code usable to obtain an updated version of the software program.

The change criteria may be adapted to discriminate whether the final set of changes is likely to introduce undesired operation of an updated version of the software program due to unintended consequences of the final set of changes. The dynamically generated set of changes may be disqualified for promotion to the final set of changes until the dynamically generated set of changes meets the change criteria. Upon obtaining the final set of changes, an integration process may be performed using the final set of changes to obtain the updated version of the software program, and/or other actions may be identified to manage integration of the final set of changes into the codebase.

To perform the iterative evaluation to determine whether the dynamically generated set of changes meets the change criteria and thus, qualifies for promotion to the final set of changes, a change magnitude for the dynamically generated set of changes may be obtained. Using the change magnitude and historical data for the codebase (e.g., previous sets of changes that have been integrated into the codebase and/or change magnitudes for the previous sets of changes), change values for evaluation of the dynamically generated set of changes may be obtained. The change values may include a change magnitude average and a change magnitude standard deviation should the dynamically generated set of changes be integrated into the codebase. A determination may be made regarding whether the change values meet the change criteria. The entity may be made aware of the acceptability of the dynamically generated set of changes (e.g., whether the dynamically generated meets the change criteria).

Obtaining the change magnitude for the dynamically generated set of changes may include obtaining a criticality value and a similarity value for the dynamically generated set of changes. The criticality value may indicate a degree of impact of integrating the dynamically generated set of changes into the codebase. For example, the criticality value may be evaluated based on a number of application programming interfaces (APIs) of an API call chain impacted by the dynamically generated set of changes. The similarity value may indicate a degree of similarity between the source code before and the source code after the integration of the dynamically generated set of changes into the codebase (e.g., based on changes in functionality of the software program and/or other similarity metrics).

Thus, embodiments disclosed herein may address, among other technical problems, the technical challenge of integrating sets of changes into codebases. By managing integration of a set of changes into a codebase for a software program by iteratively evaluating a dynamically generated (e.g., provisional) set of changes during the generation process, a likelihood of errors being introduced into the codebase and/or other undesired impacts on the functionality of the software program may be reduced. Consequently, a likelihood of providing the computer-implemented services using the software program in a manner that meets the expectations of a downstream consumer of the computer-implemented services may be improved.

In an embodiment, a method for providing computer-implemented services using a data processing system is disclosed. The method may include: iteratively evaluating a dynamically generated set of changes for a codebase until a final set of changes meeting change criteria is obtained, the codebase including source code for a software program, the change criteria being adapted to discriminate whether the final set of changes is likely to introduce undesired operation of an updated version of the software program due to unintended consequences of the final set of changes, and the final set of changes including changes to the source code usable to obtain the updated version of the software program; and performing, using the final set of changes, an integration process to obtain the updated version of the software program to continue provision of the computer-implemented services.

Iteratively evaluating the dynamically generated set of changes may include: obtaining the dynamically generated set of changes from an entity through a graphical user interface (GUI); performing, using the dynamically generated set of changes, an analysis process to obtain a result, the result indicating whether the dynamically generated set of changes meets the change criteria; and updating the graphical user interface to reflect at least a portion of the result.

Performing the analysis process may include: obtaining, using the dynamically generated set of changes, a change magnitude for the dynamically generated set of changes, the change magnitude indicating a level of change to the source code should the dynamically generated set of changes be integrated into the codebase; obtaining, using the change magnitude and historical data for the codebase, change values for evaluation of the dynamically generated set of changes; and making a determination, based on the change values, regarding whether the change values meet the change criteria to obtain the result.

Obtaining the change magnitude may include: obtaining, using the dynamically generated set of changes and the codebase, a criticality value for the set of changes; obtaining, using the dynamically generated set of changes and the codebase, a similarity value for the dynamically generated set of changes; and obtaining, using at least the criticality value and the similarity value, the change magnitude.

Obtaining the criticality value may include: evaluating a degree of impact of integrating the dynamically generated set of changes into the codebase, the degree of impact being based on a number of application programming interfaces (APIs) impacted by the dynamically generated set of changes; and assigning, based on the degree of impact, the criticality value.

Obtaining the similarity value may include: obtaining, using the dynamically generated set of changes and a trained machine learning model, a first summary of the dynamically generated set of changes and a second summary of at least a portion of the source code that would be impacted by integrating the dynamically generated set of changes into the codebase; comparing the first summary and the second summary to obtain a difference, and assigning, based on the difference, the similarity value.

The change magnitude may be a weighted sum of the criticality value and the similarity value.

The change values may include a change magnitude average and a change magnitude standard deviation should the dynamically generated set of changes be integrated into the codebase.

The historical data may include: previous sets of changes that have been integrated into the codebase; and change magnitudes for the previous sets of changes.

Obtaining the change values may include: obtaining, using the change magnitudes for the previous sets of changes and the change magnitude for the dynamically generated set of changes, the change magnitude average; and obtaining, using the change magnitudes for the previous sets of changes and the change magnitude for the dynamically generated set of changes, the change magnitude standard deviation.

The change criteria may include a threshold value for the change values, and meeting the threshold value may indicate that the dynamically generated set of changes has an unacceptable level of deviation from the historical data to be integrated into the codebase.

The unacceptable level of deviation from the historical data may indicate integrating the dynamically generated set of changes into the codebase has an unacceptable risk of undesired impacts on the updated version of the software program.

The GUI may be updated temporally with changes made by the entity to obtain the dynamically generated set of changes so that the entity is made aware of acceptability of the dynamically generated set of changes due to the changes made by the entity.

The acceptability may be whether the dynamically generated set of changes meets the change criteria.

The dynamically generated set of changes may be disqualified for promotion to the final set of changes until the dynamically generated set of changes meets the change criteria.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

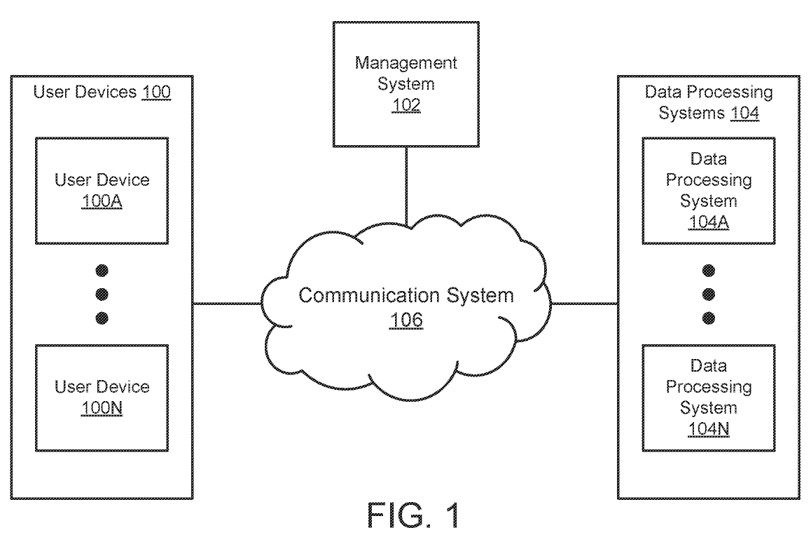

Turning to FIG. 1, a block diagram illustrating a system in accordance with an embodiment is shown. The system shown in FIG. 1 may provide computer-implemented services. The computer implemented services may include any type and quantity of computer-implemented services. For example, the computer-implemented services may include data storage services, instant messaging services, database services, and/or any other type of service that may be implemented with a computing device. Other types of computer-implemented services may be provided by the system without departing from embodiments disclosed herein.

The computer-implemented services may be provided using data processing systems 104 (and/or other devices) to any number of downstream consumers of the computer-implemented services (e.g., users of data processing systems 104 such as businesses and/or individuals). Data processing systems 104 may include any number of hardware components, such as processors, memory modules, storage devices, communication devices, etc. The hardware components of data processing systems 104 may support execution of any number and/or type of software components (e.g., applications and/or other types of software programs). Changes in available functionalities of the hardware components and/or the software components of data processing systems 104 may provide for various types of different computer-implemented services to be provided to the downstream consumers.

Over time, the software components of data processing systems 104 may be modified. For example, portions of the software components may be updated to improve performance of data processing systems 104, add functionality to data processing systems 104, reduce a security risk associated with a portion of the software components, etc. Updates and/or other modifications made to the software components of data processing systems 104 may allow for additional computer-implemented services to be provided, more reliable computer-implemented services to be provided, the computer-implemented services to be provided in a more secure manner, and/or other improvements to the computer-implemented services provided to the downstream consumers.

To modify the software components of data processing systems 104, the system may include any number of user devices 100. User devices 100 may be used by users such as programmers, developers, engineers, semi and/or fully automated entities, and/or other users to generate, update, modify, and/or otherwise manage at least a portion of the software components of data processing systems 104. For example, user devices 100 may be used to modify the software components by integrating changes to source code for a software program (e.g., a portion of the software components) into a codebase for the software program.

However, integrating the changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumers using the software program may be delayed, provided in a manner that does not meet the expectations of the downstream consumers, and/or may otherwise be negatively impacted.

In general, embodiments disclosed herein may provide methods, systems, and/or devices for integrating changes to source code for a software program into a codebase in a manner that reduces a likelihood of negatively impacting computer-implemented services provided using the software program. To do so, a dynamically generated set of changes (e.g., a provisional set of changes being generated by an entity using, for example, development environment software) for the codebase may be obtained (e.g., from the entity through a graphical user interface (GUI)). The dynamically generated set of changes may be iteratively evaluated until a final set of changes meeting change criteria is obtained. The final set of changes may include changes to the source code usable to obtain an updated version of the software program.

The change criteria may be adapted to discriminate whether the final set of changes is likely to introduce undesired operation of an updated version of the software program due to unintended consequences of the final set of changes. The dynamically generated set of changes may be disqualified for promotion to the final set of changes until the dynamically generated set of changes meets the change criteria.

To perform the iterative evaluation to determine whether the dynamically generated set of changes meets the change criteria, a change magnitude for the dynamically generated set of changes may be obtained. Using the change magnitude and historical data for the codebase (e.g., previous sets of changes that have been integrated into the codebase and/or change magnitudes for the previous sets of changes), change values for evaluation of the dynamically generated set of changes may be obtained. The change values may include a change magnitude average and a change magnitude standard deviation should the dynamically generated set of changes be integrated into the codebase. A determination may be made regarding whether the change values meet the change criteria. The entity may be made aware of the acceptability of the dynamically generated set of changes (e.g., whether the dynamically generated meets the change criteria).

Based on the determination, the dynamically generated set of changes may qualify for promotion to the final set of changes. For example, the dynamically generated set of changes may qualify for promotion to the final set of changes if the dynamically generated set of changes meets the change criteria. The final set of changes (e.g., upon submission for integration, review, and/or other testing processes) may be used to perform an integration process to obtain the updated version of the software program, and/or other actions may be identified to manage integration of the final set of changes into the codebase.

Obtaining the change magnitude for the dynamically generated set of changes may include obtaining a criticality value and a similarity value for the dynamically generated set of changes. The criticality value may indicate a degree of impact of integrating the dynamically generated set of changes into the codebase. For example, the criticality value may be evaluated based on a number of application programming interfaces (APIs) of an API call chain impacted by the dynamically generated set of changes. The similarity value may indicate a degree of similarity between the source code before and the source code after the integration of the dynamically generated set of changes into the codebase (e.g., based on changes in functionality of the software program and/or other similarity metrics).

By performing an iterative evaluation process for the dynamically generated set of changes, the entity generating the dynamically generated set of changes may be notified (e.g., during the generation process) of whether the dynamically generated set of changes meets the change criteria. In doing so, embodiments disclosed herein may reduce a likelihood of errors being introduced into the codebase and/or other undesired impacts on the functionality of the software program. As a result, a likelihood of providing the computer-implemented services in a manner that meets the expectations of downstream consumers of the computer-implemented services may be improved.

To provide the above noted functionality, the system of FIG. 1 may include user devices 100, management system 102, data processing systems 104, and communication system 106. Each of these components is discussed below.

Data processing systems 104 may include any number and/or type of data processing systems (e.g., 104A-104N). Each data processing system of data processing systems 104 may include hardware and/or software components (e.g., software programs) configured to facilitate the provision of all, or a portion of, the computer-implemented services to downstream consumers of the computer-implemented services (e.g., users of data processing systems 104). The downstream consumers may include, for example, businesses, individuals, and/or other users that may consume computer-implemented services provided using data processing systems 104.

For example, a data processing system (e.g., data processing system 104A) may be used by a hospital (e.g., a downstream consumer) to store patient information. The computer-implemented services provided using data processing system 104A may include secure data storage services, which may be facilitated using a security program (e.g., a software component of data processing system 104A). The security program may be used to encrypt the patient information, regulate access to the patient information, and/or otherwise protect the patient information from being accessed by unauthorized entities.

The software programs may be generated, updated, modified, and/or otherwise maintained using user devices 100. User devices 100 may include any type and/or quantity of user devices (e.g., 100A-100N), which may include data processing systems and/or other computing devices. Users of user devices 100 may have various roles related to maintaining and/or modifying the functionality software programs of data processing systems 104. For example, the user roles may include writing initial source code for the software programs, identifying functionalities (e.g., desired by the downstream consumers) to be added to the software programs, identifying security vulnerabilities of the software programs, obtaining (e.g., generating) sets of changes for codebases associated with the software programs, and/or performing other tasks.

For example, users of user devices 100 may dynamically generate (e.g., write code for) sets of changes for codebases using programs hosted by user devices 100 such as development environment software (e.g., integrated development environments (IDEs)). The development environment software may be used by the users to write, run, debug, test, and/or perform other tasks to dynamically generate the sets of changes and/or otherwise prepare the sets of changes for integration into the codebases. The development environment software may include any type of development environment software (e.g., Intellij, Visual Studio, Eclipse, NetBeans, etc.), and may include GUIs, compilers for code, databases for storing code, etc.

The sets of changes may be obtained to: (i) address bugs and/or other errors in the source code (e.g., that cause the software programs to operate in unexpected and/or undesired manners), (ii) improve performance of the software programs (e.g., to allow the software programs to run faster, use less memory, and/or consume fewer resources), (iii) address security vulnerabilities, (iv) add the desired functionalities to the software programs, (iv) adapt to changes in underlying environments and/or technologies used by the software programs, and/or (v) otherwise improve and/or maintain the software programs.

Returning to the above example, the security program used to provide the secure data storage services may be updated to improve security of the patient information and/or add functionality to the security program, such as additional authentication procedures to reduce a likelihood of the patient information being accessed by unauthorized users. A set of changes may be generated using user device 100A to update the source code of the codebase for the security program.

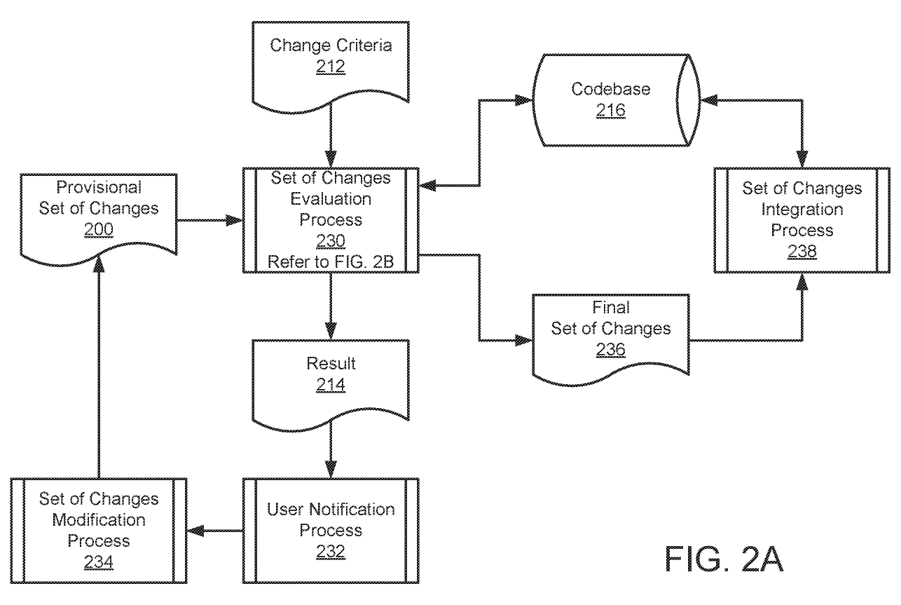

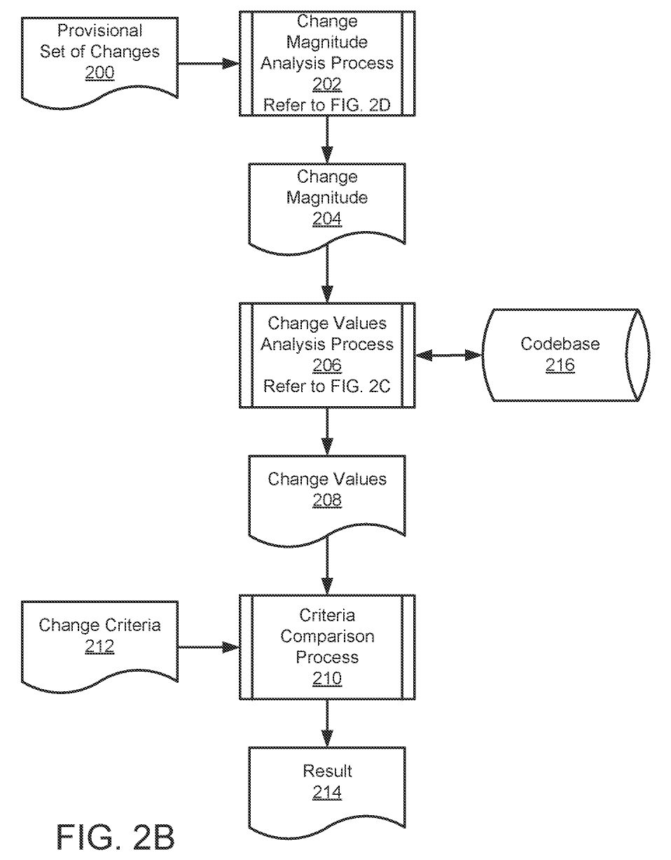

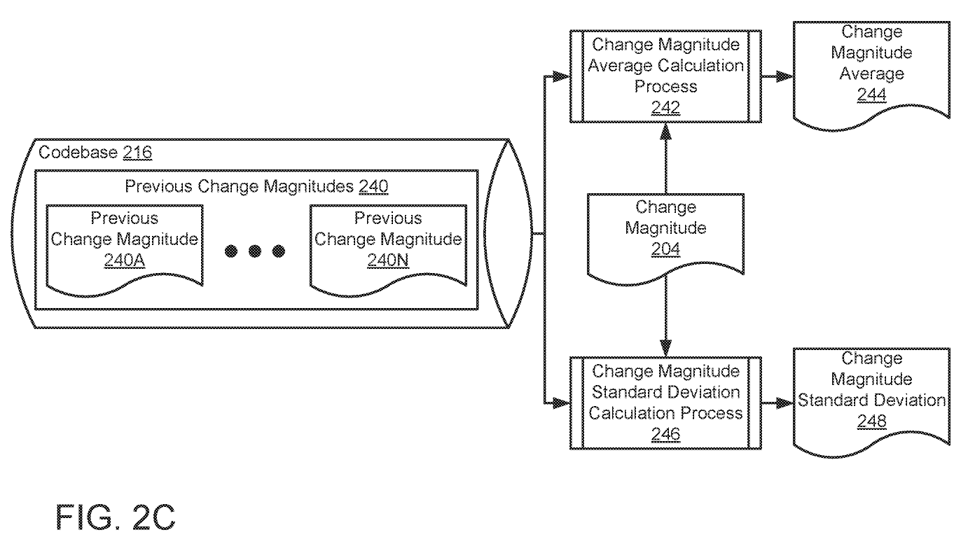

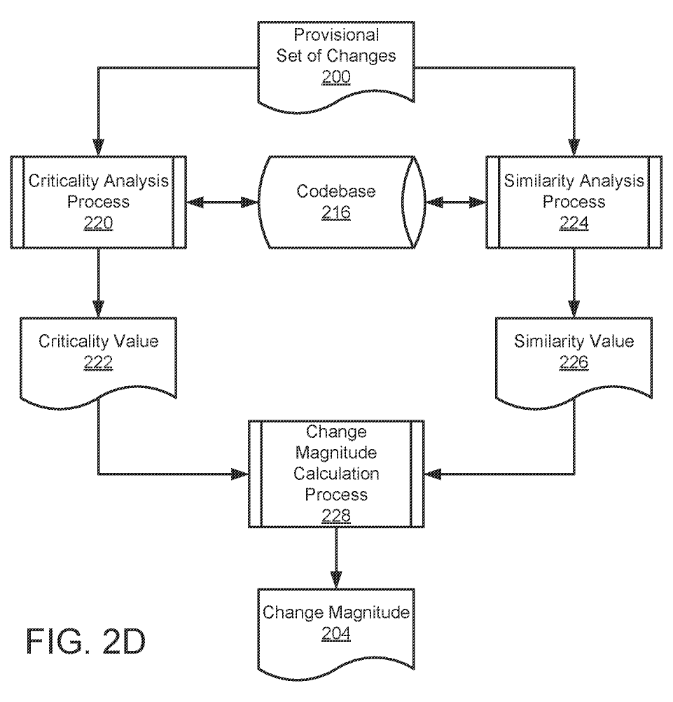

User devices 100 may be managed by management system 102. Management system 102 may include any number and/or type of devices (e.g., data processing systems) used to manage codebases and/or tasks performed by user devices 100 related to the codebases. For example, management system 102 may: (i) obtain dynamically generated (e.g., provisional) and/or final sets of changes (e.g., from user devices 100), (ii) provide feedback to the users regarding the acceptability of the dynamically generated and/or final sets of changes (e.g., during the process of generating the dynamically generated sets of changes and/or after submission of the final sets of changes), (iii) perform analyses to determine whether the dynamically generated and/or final sets of changes are acceptable (e.g., obtain change magnitudes and/or change values for evaluation of the dynamically generated and/or final sets of changes, determine whether the dynamically generated and/or final sets of changes meet change criteria and are thus acceptable), (iv) perform integration processes for the final sets of changes (e.g., establish reviewing processes for the final sets of changes, manage integration of the final sets of changes into the codebases), (v) perform tasks related to maintaining the codebases, and/or (vi) perform other tasks to facilitate provision of the computer-implemented services using the software programs used by data processing systems 104. By performing its functionality, management system 102 may reduce a likelihood of undesired impacts on the software programs as a result of integrating sets of changes into the codebases. Refer to the description of FIG. 2D for additional details regarding obtaining the change magnitudes for set of changes, and FIG. 2C for additional details regarding obtaining the change values.

When providing their functionality, any of (and/or components thereof) user devices 100, management system 102, and/or data processing systems 104 may perform all, or a portion, of the actions and methods illustrated in FIGS. 2A-4.

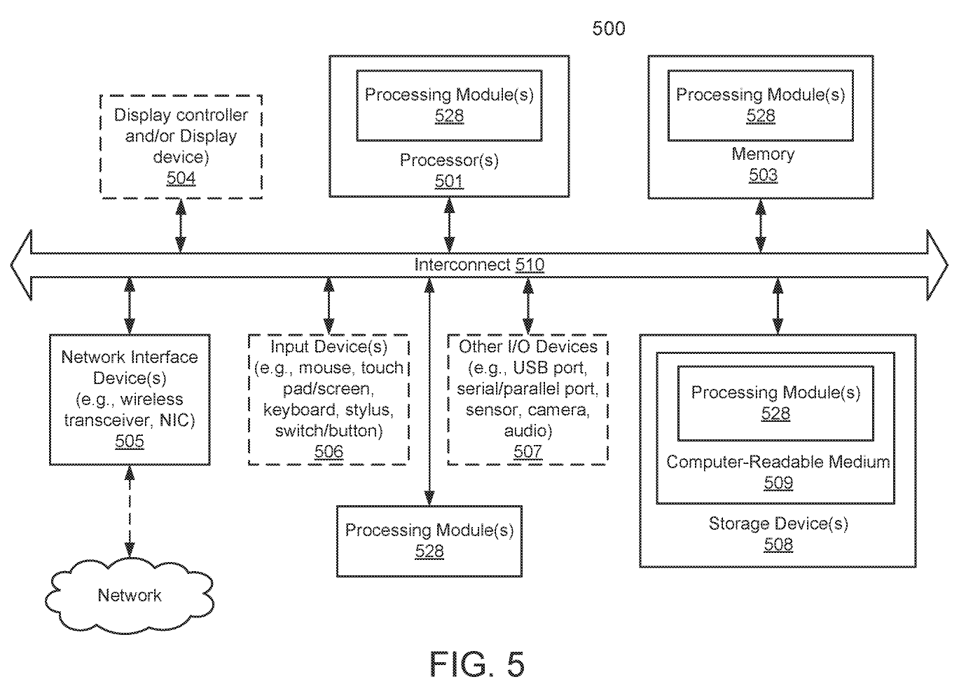

Any of (and/or components thereof) user devices 100, management system 102, and/or data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 5.

Management system 102 may be implemented with multiple computing devices. The computing devices of management system 102 may cooperatively perform processes for managing codebases. The computing devices of management system 102 may perform similar and/or different functions, and may be used by different persons (e.g., users) that may participate in the management of codebases. For example, management system 102 may include multiple computing devices used by managers, programmers, developers, engineers, and/or other users (e.g., persons) tasked with managing codebases.

Management system 102 may be maintained, for example, by a business or other entity that has some degree of responsibility with respect to managing the operation of user devices 100. For example, management system 102 may be operated by a software company that employs and/or otherwise cooperates with users of user devices 100.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to facilitate provision of computer-implemented services using a data processing system. The following processes described in FIGS. 2A-2D may be performed by the system in FIG. 1 when providing this functionality.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 212, etc.) is used to represent data structures, a second set of shapes (e.g., 230, 232, etc.) is used to represent processes performed using and/or that generate data, and a third set of shapes (e.g., 216) is used to represent large scale data structures such as databases.

Turning to FIG. 2A, a first data flow diagram in accordance with an embodiment is shown. The first data flow diagram may illustrate data used in and data processing performed in iteratively evaluating a dynamically generated set of changes (e.g., provisional set of changes 200) and managing integration of a final set of changes (e.g., final set of changes 236) into a codebase for a software program (e.g., codebase 216).

To do so, provisional set of changes 200 may be obtained for codebase 216. Codebase 216 may include source code for a software program, which may include a set of instructions and/or other code (e.g., written by programmers, software developers, semi and/or fully automated entities, and/or other entities) for performing actions related to running the software program. Codebase 216 may include source code written in any programming language (e.g., Python, HTML, C++, Java).

Provisional set of changes 200 may include a dynamically generated set of changes. For example, provisional set of changes may include a set of changes that is being generated by an entity using development environment software. Provisional set of changes 200 may not be submitted by the entity as a final set of changes (e.g., provisional set of changes 200 may be obtained during the process of writing source code modifications by the entity). The entity (e.g., a user of user devices 100 shown in FIG. 1), may include a person and/or a semi or fully automated entity (e.g., a generative artificial intelligence (AI) model). Provisional set of changes 200 may be obtained from the entity through a GUI (e.g., part of the development environment software).

Provisional set of changes 200 may include potential changes to at least a portion of the source code included in codebase 216. Provisional set of changes 200 may be intended to be used as and/or may represent a portion of final set of changes 236, which may be usable to obtain an updated version of the software program. For example, provisional set of changes 200 may include a set of alterations for the at least the portion of the source code packaged together, and/or metadata regarding the set of alterations (e.g., a description of provisional set of changes 200 provided by a user who wrote provisional set of changes 200, an identifier for the user, a date and/or time provisional set of changes 200 was written). Refer to the description of FIG. 1 for additional details regarding sets of changes for codebases.

Provisional set of changes 200 may be used to perform set of changes evaluation process 230 to obtain result 214. During set of changes evaluation process 230, provisional set of changes 200 may be iteratively evaluated until final set of changes 236 meeting change criteria 212 is obtained. To iteratively evaluate provisional set of changes 200, an analysis process may be performed for each version of provisional set of changes 200 obtained from the entity until final set of changes 236 is obtained. The analysis process may include: (i) obtaining, using provisional set of changes 200, a change magnitude for provisional set of changes 200, (ii) obtaining, using the change magnitude and historical data for codebase 216, change values for evaluation of provisional set of changes 200, and/or (iii) making a determination, based on the change values, regarding whether the change values meet change criteria 212. Refer to the description of FIG. 2B for additional details regarding set of changes evaluation process 230.

As a result of set of changes evaluation process 230, result 214 may be obtained. Result 214 may include an indication of whether provisional set of changes 200 meets change criteria 212. For example, result 214 may include: (i) a “yes” or “no” answer, (ii) a value representing a difference between any values obtained during set of changes evaluation process 230 (e.g., the change values, the change magnitude) and any values of change criteria 212 (e.g., threshold values), and/or (iii) other quantities and/or information.

Upon obtaining result 214, user notification process 232 may be performed. During user notification process 232, the GUI (e.g., part of the development environment software through which provisional set of changes 200 was obtained) may be updated to reflect at least a portion of result 214. For example, the GUI may be updated to indicate to the entity whether provisional set of changes 200 meets change criteria 212, and/or the change magnitude for provisional set of changes 200. The GUI may be updated, for example, using a plugin (e.g., a piece of software) added to the development environment software.

The GUI may be updated temporally with changes made by the entity to obtain provisional set of changes 200 so that the entity is made aware of acceptability of provisional set of changes 200 due to the changes made by the entity. For example, the GUI may be updated to include a notification indicating to the entity whether provisional set of changes 200 meets change criteria 212 (and is thus, acceptable).

For example, a user may be tasked with generating a set of changes to update a software program using development environment software. The user may be an employee of a software company that manages a codebase for the software program. To reduce a likelihood of introducing errors into the codebase, the software company may have a policy (e.g., criteria) limiting change magnitudes and/or change values for sets of changes. To assist the user in the process of generating the set of changes, the user may receive notifications via a GUI of the development environment software indicating whether the set of changes being dynamically generated by the user is compliant with the policy (e.g., meets the criteria).

The notification provided to the entity via the GUI may be used to perform set of changes modification process 234. During set of changes modification process 234, provisional set of changes 200 may be edited, updated, and/or otherwise modified by the entity based on information included in the notification to obtain an updated version of provisional set of changes 200. For example, if the notification indicates provisional set of changes 200 meets change criteria 212 (e.g., the change values for evaluation of provisional set of changes 200 are below threshold change values included as part of change criteria 212), the entity may add additional changes to provisional set of changes 200. If the notification indicates provisional set of changes 200 does not meet change criteria 212 (e.g., the change values for evaluation of provisional set of changes 200 exceed threshold change values included as part of change criteria 212), the entity may remove a portion of the changes included in provisional set of changes 200. Notifications regarding the acceptability of provisional set of changes 200 may be provided to the entity over time as the entity continues to modify provisional set of changes 200.

For example, a user (e.g., an entity) may be using a development environment software program to write changes to source code for a software program. The user may interact with the development environment software through a GUI, and the development environment software may include a plugin having functionality to iteratively evaluate the changes made by the user. As the user writes the changes, a provisional set of changes may be obtained, the provisional set of changes representing a snapshot of the changes made by the user at a point in time. The provisional set of changes may be evaluated using change criteria (e.g., obtained from a management entity of the software program), and the user may be provided a notification through the GUI in real time. The notification may indicate whether the provisional set of changes meets the change criteria, and/or values indicating an extent to which the provisional set of changes differs from values included as part of the change criteria (e.g., threshold values). In doing so, the user may update the provisional set of changes using feedback obtained via the notification, rather than obtaining the feedback after submission of a final set of changes. The user may continue to receive notifications while continuing to modify the changes until the final set of changes meeting the change criteria is obtained.

As provisional set of changes 200 is iteratively evaluated, final set of changes 236 may be obtained. Final set of changes 236 may include a copy and/or version of provisional set of changes 200 that has been promoted to a final (e.g., completed) set of changes. Final set of changes 236 may meet change criteria 212. Thus, any version of provisional set of changes 200 which does not meet change criteria 212 may be disqualified for promotion to final set of changes 236. Provisional set of changes 200 may be promoted to final set of changes 236 if the entity and/or a management entity of the entity (e.g., management system 102 shown in FIG. 1) indicates provisional set of changes 200 is completed, and provisional set of changes 200 meets change criteria 212.

Change criteria 212 may be adapted to discriminate whether final set of changes 236 is likely to introduce undesired operation of the updated version of the software program due to unintended consequences of final set of changes 236. The unintended consequences may result in the undesired operation of the software program by: (i) introducing bugs and/or errors into the software program resulting in a reduced ability of the software program to be used to provide computer-implemented services, (ii) reducing maintainability of the software program resulting in difficulties updating the software program in the future, (iii) introducing undesired impacts on downstream and/or upstream software programs, (iv) introducing security issues (e.g., introduce new security vulnerabilities and/or expose existing security vulnerabilities), and/or result in other undesired operations of the software program. Meeting change criteria 212, for example, may indicate that final set of changes 236 exhibits an acceptable level of risk of the unintended consequences.

Upon obtaining final set of changes 236, set of changes integration process 238 may be performed. During set of changes integration process 238, review and/or testing processes may be performed for final set of changes 236 prior to integrating final set of changes 236 into codebase 216. During the review and/or testing processes, final set of changes 236 may be reviewed (e.g., by users of user devices 100 shown in FIG. 1 and/or semi or fully automated entities, also called reviewers) to determine whether final set of changes 236 is to be integrated into codebase 216. The reviewers for final set of changes 236 may be identified based on a change magnitude for final set of changes 236, change values for evaluation of final set of changes 236, and/or any other change characteristics for final set of changes 236.

Performing review and/or testing processes may include initiating review and/or testing of final set of changes 236 to obtain outcomes. The outcomes may include results obtained from the reviewers and/or results of any tests performed using final set of changes 236. The outcomes may indicate whether corresponding portions of the source code as modified by final set of changes 236 meet functional specification requirements for the updated version of the software program. The functional specification requirements may include an ability of the updated version of the software program to perform its functionality (e.g., as desired by a consumer of computer-implemented services provided using the updated version of the software program) without introducing undesired impacts on the updated version of the software program (and/or upstream dependencies of functionalities of the updated version of the software program).

The outcomes may be used to determine whether to integrate final set of changes 236 into codebase 216. For example, the outcomes may include: (i) an indication of whether the reviewers determine that final set of changes 236 meets the functional specification requirements (e.g., a “yes” or “no” indication), (ii) any comments from the reviewers obtained during performance of the review and/or testing processes (e.g., feedback and/or edits for final set of changes 236), and/or (iii) other information.

If the outcomes indicate final set of changes 236 meets the functional specification requirements, final set of changes 236 may be integrated into codebase 216 to obtain the updated version of the software program to continue provision of the computer-implemented services (e.g., portions of source code included in codebase 216 may be modified, replaced, and/or added to based on final set of changes 236).

If the outcomes indicate final set of changes 236 does not meet the functional specification requirements, at least one action may be identified (e.g., based on a policy obtained from a management entity) to manage integration of final set of changes 236 into codebase 216. For example, the at least one action may include: (i) rejecting at least a portion of final set of changes 236, (ii) returning final set of changes 236 to the entity for further modification, (iii) assigning another entity (e.g., a user of user devices 100 shown in FIG. 1) to edit final set of changes 236 (e.g., based on feedback and/or edits received from the reviewers as part of the outcomes) prior to integrating final set of changes 236 into codebase 216, and/or (iv) other actions.

Thus, by implementing the processes illustrated in FIG. 2A, a system in accordance with embodiments disclosed herein may be used to iteratively evaluate a dynamically generated (e.g., provisional) set of changes to obtain a final set of changes meeting change criteria. The final set of changes may be used to perform an integration process to obtain an updated version of a software program usable to provide computer-implemented services.

Turning to FIG. 2B, a second data flow diagram in accordance with an embodiment is shown. The second data flow diagram may illustrate data used in and data processing performed in performing an analysis process using a dynamically generated set of changes (e.g., provisional set of changes 200) to obtain a result (e.g., result 214). The processes described in FIG. 2B may be an expansion of set of changes evaluation process 230 shown in FIG. 2A.

To perform the analysis process, provisional set of changes 200 may be used to perform change magnitude analysis process 202 to obtain change magnitude 204. Change magnitude 204 may indicate a level of change to the source code should provisional set of changes 200 be integrated into codebase 216 (e.g., upon promotion of provisional set of changes to final set of changes 236 shown in FIG. 2A). For example, the level of change may include a difference in functionality of the software program before and after integration of provisional set of changes 200 (e.g., rather than a change in size of the source code). For example, obtaining a higher change magnitude 204 (e.g., based on a numerical and/or any other type of scale) may indicate integrating provisional set of changes 200 into codebase 216 has an increased risk of undesired and/or unintended impacts on the updated version of the software program. For additional details regarding performing change magnitude analysis process 202 and/or change magnitude 204, refer to the description of FIG. 2D.

For example, a data processing system (e.g., of data processing systems 104 described in FIG. 1) may include an antivirus software program. The antivirus software program may include functionalities for detecting malware on the data processing system. A first set of changes may be obtained for the antivirus software program including minor revisions to the source code intended to enhance readability of a portion of the source code. A change magnitude of 2 (e.g., on a scale of 1-10, where a change magnitude of 10 represents the highest level of change to the source code) may be obtained for the first set of changes. A second set of changes may be obtained for the antivirus software program intended to add functionality of the antivirus software program to remove detected malware from the data processing system. The second set of changes may include revising a larger portion of the source code relative to the first set of changes. As a result, a change magnitude of 8 may be obtained for the second set of changes. Thus, integrating the second set of changes into the codebase may have a higher risk of undesired impacts on the antivirus software program than integrating the first set of changes into the codebase.

Change magnitude 204 may then be used to perform change values analysis process 206. During change values analysis process 206, change magnitude 204 and historical data for codebase 216 may be used to perform an analysis process to obtain change values 208. The historical data for codebase 216 may include: (i) previous sets of changes that have been integrated into codebase 216, (ii) change magnitudes for the previous sets of changes (e.g., calculated using similar or different methods to those described in FIG. 2D), and/or (iii) other historical data. The historical data may be stored as part of codebase 216 (and/or in a separate storage) and may be obtained during performance of change values analysis process 206. Refer to the description of FIG. 2C for additional details regarding change values analysis process 206.

As a result of change values analysis process 206, change values 208 may be obtained. Change values 208 may be usable to evaluate provisional set of changes 200 to determine whether provisional set of changes 200 is qualified for promotion to the final set of changes, and may include: (i) a change magnitude average, and/or (ii) a change magnitude standard deviation should provisional set of changes 200 be integrated into codebase 216. The change magnitude average and the change magnitude standard deviation may be calculated using change magnitude 204 and change magnitudes for previous sets of changes (e.g., historical data). In doing so, the change magnitude average may indicate an average change magnitude for sets of changes for codebase 216 (e.g., including the previous sets of changes and provisional set of changes 200) should provisional set of changes 200 be integrated into codebase 216, and the change magnitude standard deviation may indicate a level of deviation of the sets of changes in codebase 216 should provisional set of changes 200 be integrated into codebase 216.

While described with respect to change values 208 including a change magnitude average and a change magnitude standard deviation, it will be appreciated that any other values may be obtained using the change magnitude to evaluate provisional set of changes 200. For example, the change values may include a change magnitude median, change magnitude mode, change magnitude standard error, and/or any other metric and/or statistical characterization for provisional set of changes 200.

Using change values 208, criteria comparison process 210 may be performed. During criteria comparison process 210, a determination may be made regarding whether change values 208 meets change criteria 212 (e.g., by an entity responsible for managing sets of changes for codebases, such as management system 102 described in FIG. 1). Change criteria 212 may be provided by a downstream consumer (e.g., obtained from any of data processing systems 104), a subject matter expert (SME), and/or any other entity participating in managing the integration of sets of changes into codebase 216. Change criteria 212 may include any number of thresholds, rule sets, formulas, and/or other means of determining whether values of change values 208 indicates provisional set of changes 200 is to be promoted to the final set of changes.

For example, change criteria 212 may include a threshold value (and/or a plurality of threshold values and/or ranges of threshold values) for change values 208, and meeting the threshold value (e.g., any of the change values equal or exceed the threshold value and/or any other definition of meeting the threshold value) may indicate that provisional set of changes 200 has an unacceptable level of deviation from the historical data to be promoted to the final set of changes and/or integrated into codebase 216. The unacceptable level of deviation from the historical data may indicate that integrating provisional set of changes 200 (and/or the final set of changes based on provisional set of changes 200) into codebase 216 has an unacceptable risk of undesired impacts on the updated version of the software program.

The level of deviation may indicate a degree to which change magnitude 204 for provisional set of changes 200 differs from change magnitudes for previous sets of changes (e.g., included in the historical data). For example, if the change magnitude average and/or the change magnitude standard deviation obtained using provisional set of changes 200 exceeds corresponding threshold values included in change criteria 212, it may indicate that change magnitude 204 has a level of deviation from the historical data that is too high to be considered acceptable for integration into codebase 216.

For example, a set of changes for a codebase for a software program may be obtained, and change values for evaluating the set of changes may be calculated. The change values may include: (i) a change magnitude average of 85 on a scale of 1-100, where 1 indicates a lowest level of change to the source code, and 100 indicates a highest level of change to the source code, and (ii) a change magnitude standard deviation of 8. Change criteria for evaluating sets of changes for the software program may be set by a management entity of the software program, such as a software company that produces the software program. The change criteria, for example, may indicate a threshold change magnitude average of 50 and a threshold change magnitude standard deviation of 10 to permit the set of changes to be integrated into the codebase. Therefore, in this example, the change magnitude average would exceed the threshold change magnitude average for the set of changes to be considered acceptable, and the set of changes would not meet the change criteria. As a result, the set of changes may not be integrated into the codebase (e.g., without modification and/or other changes) to mitigate a risk of undesired impacts on the software program.

While described above with respect to two quantities and two corresponding thresholds, it will be appreciated that any number of quantities may be compared to any number of corresponding thresholds and/or any other types of formulas or rules may be applied to determine whether change criteria are met without departing from embodiments disclosed herein. For example, the thresholds included in the change criteria may include a range of acceptable change values, and change values outside of the range may indicate the change values do not meet the change criteria. In another example, the change values may be used as input for an algorithm, and the algorithm may be used to determine whether the change values meet the change criteria.

As a result of criteria comparison process 210, result 214 may be obtained. Result 214 may be based on an outcome of criteria comparison process 210, and may include an indication of whether provisional set of changes 200 meets change criteria 212. For example, if the outcome of criteria comparison process 210 indicates that change values 208 meets change criteria 212, result 214 may indicate that provisional set of changes 200 meets change criteria 212. If the outcome indicates that at least a portion of change values 208 do not meet change criteria 212, result 214 may indicate that provisional set of changes 200 does not meet change criteria 212. Refer to the description of FIG. 2A for additional details regarding result 214.

Turning to FIG. 2C, a third data flow diagram in accordance with an embodiment is shown. The third data flow diagram may illustrate data used in and data processing performed in obtaining change values (e.g., change values 208) for evaluation of a dynamically generated set of changes (e.g., provisional set of changes 200, not shown). FIG. 2C may be an expansion of change values analysis process 206 shown in FIG. 2B.

Change values 208 may include change magnitude average 244 and/or change magnitude standard deviation 248. Change magnitude average 244 may include an average (e.g., mean) and/or other representative value of the change magnitude of sets of changes for codebase 216 should provisional set of changes 200 be integrated into codebase 216. Change magnitude standard deviation 248 may include a standard deviation and/or other representative value of the variance in change magnitudes of sets of changes for codebase 216 should provisional set of changes 200 be integrated into codebase 216.

To obtain change magnitude average 244, change magnitude average calculation process 242 may be performed. During change magnitude average calculation process 242, change magnitude 204 (e.g., the change magnitude for the set of changes) and previous change magnitudes 240 may be used to obtain change magnitude average 244. Previous change magnitudes 240 may include any number of change magnitudes (e.g., 240A-240N) for previous sets of changes that have been integrated into codebase 216 (e.g., a part of the historical data for codebase 216).

For example, codebase 216 may have been modified previously using three sets of changes: a first previous set of changes, a second previous set of changes, and a third previous set of changes. Each previous set of changes may be associated with a change magnitude (e.g., calculated using similar or different methods to those described in FIG. 2D). In this example, previous change magnitudes 240 may include three change magnitudes: previous change magnitude 240A, previous change magnitude 240B, and previous change magnitude 240C.

To obtain change magnitude average 244, a value of change magnitude 204 may be averaged with values of previous change magnitudes 240 (and/or any other type of algorithm or equation may be used to calculate change magnitude average 244). Returning to the above example, previous change magnitude 240A may have a value of 10, previous change magnitude 240B may have a value of 15, and previous change magnitude 240C may have a value of 13. Change magnitude 204 may have a value of 17. Thus, by averaging previous change magnitudes 240 and change magnitude 204, change magnitude average 244 may be obtained having a value of 13.75.

To obtain change magnitude standard deviation 248, change magnitude standard deviation calculation process 246 may be performed. During change magnitude standard deviation calculation process 246, the standard deviation of the mean and/or any other representative value of variance may be calculated using change magnitude 204 (e.g., the change magnitude for the provisional set of changes) and previous change magnitudes 240. Returning to the above example, change magnitude standard deviation 248 may be calculated using the three previous change magnitudes (e.g., 10, 15, and 13) and change magnitude 204 (e.g., 17) to obtain change magnitude standard deviation 248 having a value of 2.99.

The change values (e.g., change magnitude average 244 and change magnitude standard deviation 248) may then be used to evaluate provisional set of changes 200. Refer to the description of FIG. 2B for additional details regarding using change values to evaluate sets of changes.

Turning to FIG. 2D, a fourth data flow diagram in accordance with an embodiment is shown. The fourth data flow diagram may illustrate data used in and data processing performed in obtaining a change magnitude (e.g., change magnitude 204) for a dynamically generated set of changes (e.g., provisional set of changes 200). FIG. 2D may be an expansion of change magnitude analysis process 202 shown in FIG. 2B.

Obtaining change magnitude 204 may include (i) obtaining, using provisional set of changes 200 and codebase 216, criticality value 222 for provisional set of changes 200, (ii) obtaining, using provisional set of changes 200 and codebase 216, similarity value 226 for provisional set of changes 200, (iii) obtaining, using at least criticality value 222 and/or similarity value 226, change magnitude 204, and/or (iv) performing other tasks to obtain change magnitude 204.

To obtain criticality value 222, criticality analysis process 220 may be performed. During criticality analysis process 220, a degree of impact of integrating provisional set of changes 200 into codebase 216 may be evaluated. The degree of impact may be based on a number of application programming interfaces (APIs) impacted by provisional set of changes 200.

To evaluate the degree of impact of integrating provisional set of changes 200 into codebase 216, codebase 216 may be used to determine the number of APIs (e.g., of an API call chain) that would be impacted by integrating provisional set of changes 200 into codebase 216. Determining the number of APIs that would be impacted may include: (i) identifying API calls within codebase 216 that would be impacted by provisional set of changes 200, (ii) analyzing software dependencies to identify any external APIs that would be impacted by provisional set of changes 200, (iii) analyzing API documentation used by the software program to identify APIs likely to be impacted by provisional set of changes 200, and/or (iv) other methods. For example, the software program that is to be modified using provisional set of changes 200 may impact an external API, which may impact an API call chain (e.g., originating from the external API). The degree of impact may be obtained based on a number of APIs in the API call chain associated with the external API impacted by provisional set of changes 200. The degree of impact may include a value assigned based on any scale and/or rubric usable to indicate degrees of impact (e.g., a numerical scale, a letter scale, other types of scales).

Based on the degree of impact, criticality value 222 may be assigned to provisional set of changes 200. For example, criticality value 222 may be assigned based on a schema, rule set, table, and/or other type data structure usable to assign criticality values to sets of changes based on degrees of impact. For example, criticality value 222 may include a value from 1-10, where a higher value indicates a larger number of APIs would be impacted by provisional set of changes 200, and a lower value indicates fewer APIs would be impacted by provisional set of changes 200.

To obtain similarity value 226, similarity analysis process 224 may be performed. During similarity analysis process 224, provisional set of changes 200 and a trained machine learning model (e.g., a large language model (LLM) and/or other type of artificial intelligence model) may be used to obtain: (i) a first summary of provisional set of changes 200, and (ii) a second summary of at least a portion of the source code that would be impacted by integrating provisional set of changes 200 into codebase 216.

The first summary may include a description of the functionality, purpose, and/or other information regarding provisional set of changes 200. The first summary may represent the at least the portion of the source code after integration of provisional set of changes 200 into codebase 216. For example, the first summary may include human readable text generated by an LLM using provisional set of changes 200 as ingest for the LLM.

The second summary may include a description of the functionality, purpose, and/or other information regarding the at least the portion of the source code. The second summary may represent the at least the portion of the source code prior to the integration of provisional set of changes 200 into codebase 216. Obtaining the second summary may include methods similar to obtaining the first summary. For example, an LLM may be used to obtain the second summary, which may include human readable text generated using the at least the portion of the source code that would be impacted by provisional set of changes 200 from codebase 216 as ingest for the LLM.

The first summary and the second summary may be compared to obtain a difference. Comparing the first summary and the second summary may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain a difference, and/or (iii) assigning similarity value 226 to provisional set of changes 200 based on the difference. Similarity value 226 may include a value assigned based on any scale and/or rubric usable to indicate a degree of similarity between the source code before and after integration of provisional set of changes 200 into codebase 216. By comparing the first embedding and the second embedding, changes to the functionality and/or meaning of the source code, rather than changes to size/length of the source code, may be evaluated.

While described with respect to obtaining similarity value 226 using embeddings of textual summaries, it will be appreciated that any other method for assessing similarity may be used without departing from embodiments disclosed herein. For example, similarity value 226 may be obtained by feeding the first summary and the second summary into an LLM, prompting the LLM to compare the first summary and the second summary, and obtaining the difference and/or similarity value 226 as output from the LLM.

Criticality value 222 and similarity value 226 may be used to perform change magnitude calculation process 228. During change magnitude calculation process 228, change magnitude 204 may be calculated based on criticality value 222 and similarity value 226. For example, change magnitude 204 may be calculated by obtaining a combined and/or calculated value. The combined and/or calculated value may include, for example, a weighted sum of criticality value 222 and similarity value 226. Weights applied to criticality value 222 and similarity value 226 may be determined by an SME, a management entity, and/or any other entity that participates in managing integration of sets of changes into codebases (e.g., management system 102 shown in FIG. 1).

It will be appreciated that change magnitude 204 may be obtained, evaluated, and/or calculated using any other method, algorithm, and/or calculation without departing from embodiments disclosed herein.

Thus, by implementing the processes illustrated in FIGS. 2A-2D, a system in accordance with embodiments disclosed herein may he used to manage integration of a set of changes to source code into a codebase by iteratively evaluating a dynamically generated set of changes until a final set of changes meeting change criteria is obtained. To do so, the dynamically generated set of changes may be evaluated using a change magnitude and/or chang values for the dynamically generated set of changes and change criteria. By doing so, a likelihood of introducing undesired impacts to the codebase may be reduced, and computer-implemented services may be provided as desired to downstream consumers.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

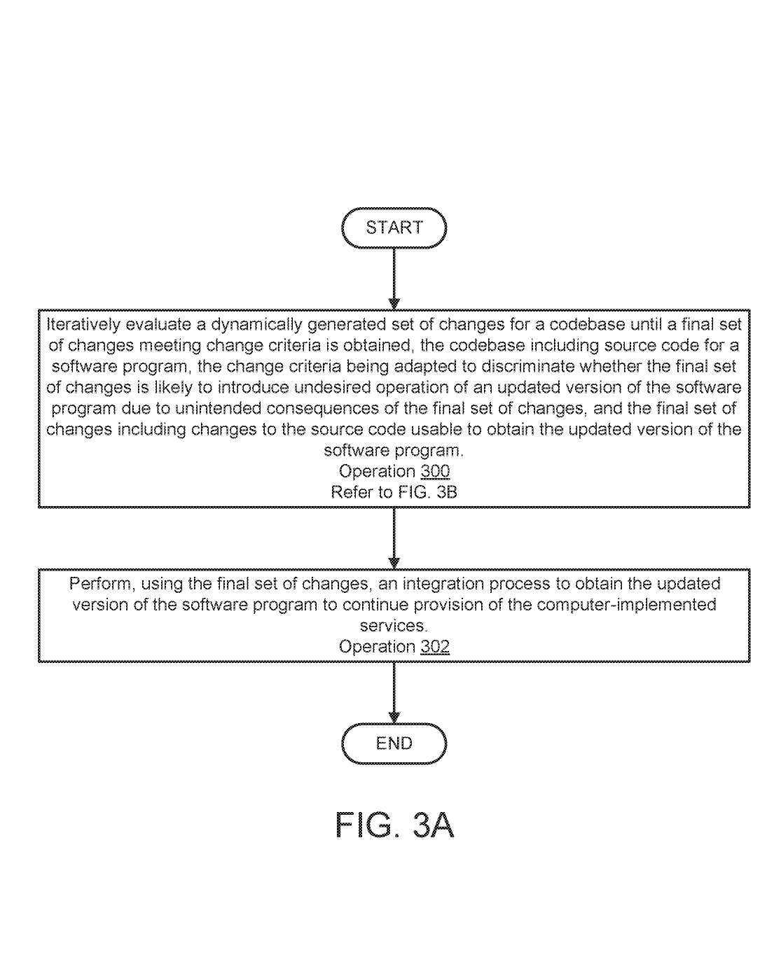

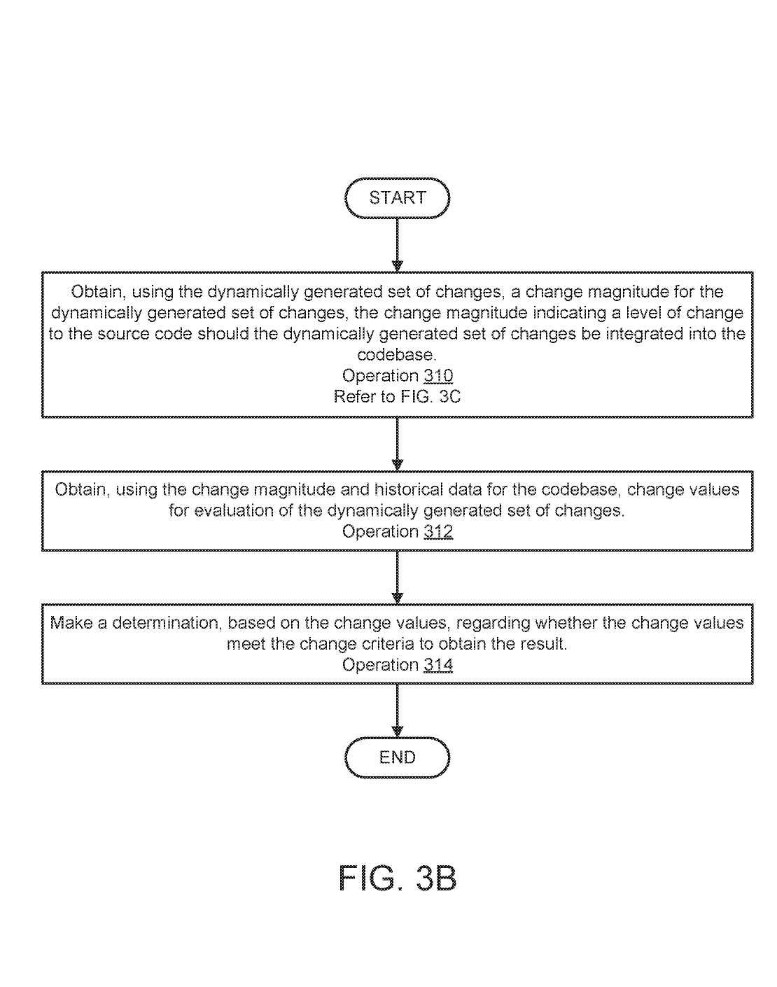

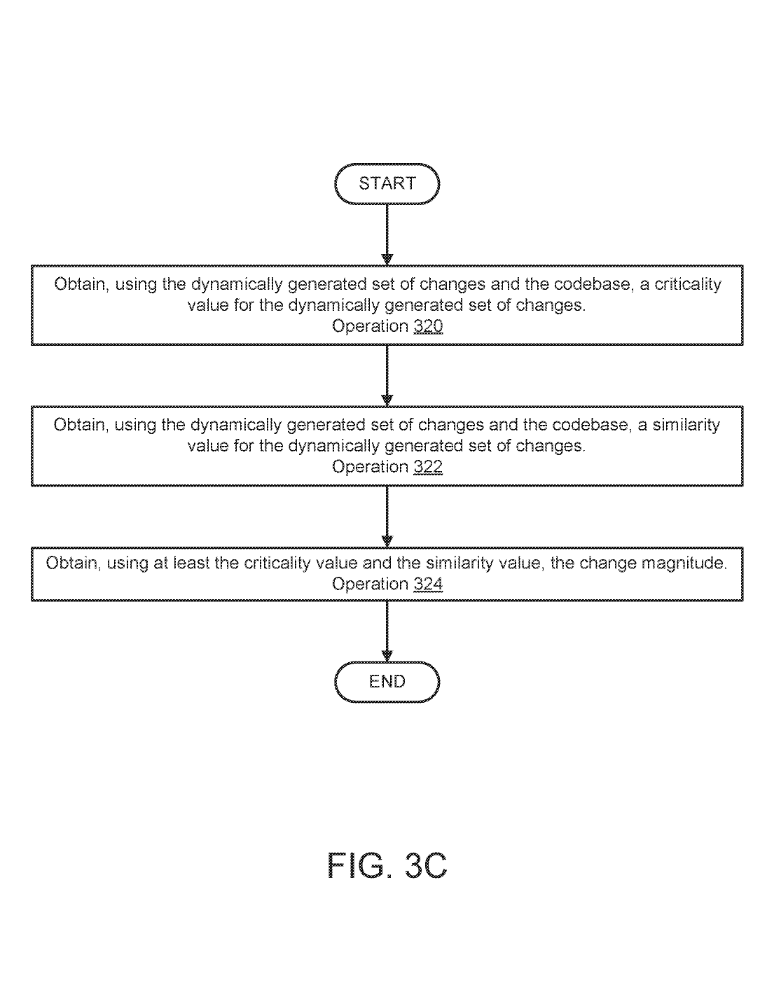

As discussed above, the components of FIG. 1 may perform various methods to provide computer-implemented services using a data processing system. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using a data processing system in accordance with an embodiment is shown. The method may be performed, for example, by any of the components of the system of FIG. 1, and/or any other entity without departing from embodiments disclosed herein.

At operation 300, a dynamically generated set of changes for a codebase may be iteratively evaluated until a final set of changes meeting change criteria is obtained. The codebase may include source code for a software program, the change criteria may be adapted to discriminate whether the final set of changes is likely to introduce undesired operation of an updated version of the software program due to unintended consequences of the final set of changes, and the final set of changes may include changes to the source code usable to obtain the updated version of the software program. Iteratively evaluating the dynamically generated set of changes may include: (i) obtaining the dynamically generated set of changes from an entity through a GUI, (ii) performing, using the dynamically generated set of changes, an analysis process to obtain a result, the result indicating whether the dynamically generated set of changes meets the change criteria, (iii) updating the GUI to reflect at least a portion of the result, (iv) obtaining, based on the result and/or input obtained from the entity, the final set of changes, (v) providing the dynamically generated set of changes to another entity responsible for iteratively evaluating the dynamically generated set of changes, and/or (vi) other methods. Refer to the description of FIG. 3B for additional details regarding performing the analysis process to obtain the result.

Obtaining the dynamically generated set of changes from the entity may include: (i) obtaining a copy of the dynamically generated set of changes during generation of changes to the source code by the entity through the GUI (e.g., via a plugin used as part of development environment software), (ii) reading the dynamically generated set of changes from storage (e.g., storing a copy of the dynamically generated set of changes in storage during generation of the changes to the source code in a storage location, reading the dynamically generated set of changes from the storage location), (iii) receiving the dynamically generated set of changes from another entity, and/or (iv) other methods.

Updating the GUI to reflect at least a portion of the result may include: (i) modifying the GUI to include a notification (e.g., text, a graphic, and/or other visual element) indicating the at least the portion of the result, (ii) providing the at least the portion of the result to another entity responsible for updating the GUI, and/or (iii) other methods.

At operation 302, the final set of changes may be used to perform an integration process to obtain the updated version of the software program to continue provision of the computer-implemented services. Performing the integration process may include performing a review process and/or testing processes to obtain outcomes indicating whether the final set of changes is appropriate for integration into the codebase. Performing the review process may include: (i) obtaining a reviewing pipeline for the final set of changes, the reviewing pipeline indicating entities that are to perform portions of the review process, an ordering between the portions of the review process, and outcomes of the portions of the review process indicating whether the final set of changes is to be integrated into the codebase, (ii) initiating review of the final set of changes using the reviewing pipeline to obtain the outcomes, the outcomes indicating whether corresponding portions of the source code as modified by the final set of changes meet functional specification requirements for the updated version of the software program, (iii) determining whether to integrate the final set of changes into the codebase using the outcomes, (iv) providing the final set of changes to another entity responsible for performing the review process, and/or (v) other methods.

Performing the integration process may also include (e.g., if it is determined that the final set of changes is to be integrated into the codebase): (i) replacing at least a portion of the source code with code included in the final set of changes to obtain the updated version of the software program, (ii) modifying at least a portion of the source code based on the final set of changes to obtain the updated version of the software program, (iii) adding code included in the final set of changes to the source code to obtain the updated version of the software program, (iv) providing the final set of changes to another entity (e.g., a management entity of the codebase) responsible for integrating the final set of changes into the codebase to obtain the updated version of the software program, (v) notifying another entity that the final set of changes is to be integrated into the codebase to obtain the updated version of the software program, and/or (vi) other methods.

The method may end following operation 302.

Turning to FIG. 3B, a second flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3B may be an expansion of operation 300 shown in FIG. 3A. The operations may be used to perform an analysis process to obtain a result, the result indicating whether the dynamically generated set of changes meets change criteria.

At operation 310, a change magnitude for the dynamically generated set of changes may be obtained using the dynamically generated set of changes, the change magnitude indicating a level of change to the source code should the dynamically generated set of changes be integrated into the codebase. Obtaining the change magnitude for the dynamically generated set of changes may include: (i) obtaining, using the dynamically generated set of changes and the codebase, a criticality value for the dynamically generated set of changes, (ii) obtaining, using the dynamically generated set of changes and the codebase, a similarity value for the dynamically generated set of changes, (iii) obtaining, using at least the criticality value and the similarity value, the change magnitude, (iv) reading the change magnitude from storage, (v) receiving the change magnitude from another entity, and/or (vi) other methods. For additional details regarding obtaining the change magnitude, refer to FIG. 3C.

At operation 312, change values for evaluation of the dynamically generated set of changes may be obtained using the change magnitude and historical data for the codebase. The change values may include a change magnitude average and a change magnitude standard deviation should the dynamically generated set of changes be integrated into the codebase. Obtaining the change values may include: (i) obtaining, using change magnitudes for previous sets of changes (e.g., included as part of the historical data) and the change magnitude for the dynamically generated set of changes, the change magnitude average, (ii) obtaining, using the change magnitudes for the previous sets of changes and the change magnitude for the dynamically generated set of changes, the change magnitude standard deviation, (iii) providing the change magnitude and/or historical data to another entity and receiving the change values in response, and/or (iv) other methods.

Obtaining the change magnitude average may include: (i) calculating the change magnitude average using the change magnitude for the dynamically generated set of changes and the change magnitudes for the previous sets of changes (e.g., using any formula and/or algorithm for calculating averages and/or other representative values), (ii) reading the change magnitude average from storage, (iii) receiving the change magnitude average from another entity, and/or (iv) other methods.

Obtaining the change magnitude standard deviation may include: (i) calculating the change magnitude standard deviation using the change magnitude for the dynamically generated set of changes and the change magnitudes for the previous sets of changes (e.g., using any formula and/or algorithm for calculating standard deviation and/or other variance values), (ii) reading the change magnitude standard deviation from storage, (iii) receiving the change magnitude standard deviation from another entity, and/or (iv) other methods.

At operation 314, a determination may be made based on the change values regarding whether the change values meet the change criteria to obtain the result. Making the determination may include: (i) obtaining the change criteria, the change criteria including a threshold value for the change values (e.g., receiving the change criteria from another entity, reading the change criteria from storage, generating the change criteria), (ii) comparing the change values to the change criteria to obtain an outcome, (iii) obtaining, based on the outcome, the result indicating whether the dynamically generated set of changes meets the change criteria, (iv) providing the change values to another entity and receiving the result in response, and/or (v) other methods.

Comparing the change values to the change criteria may include methods similar to those described with respect to criteria comparison process 210 shown in FIG. 2B. For example, comparing the change values to the change criteria may include: (i) comparing a quantity of the change values (e.g., the change magnitude average, the change magnitude standard deviation) to a quantity included in the change criteria (e.g., the threshold value and/or any other value) to obtain the outcome indicating whether the change values meet the change criteria, (ii) comparing the quantity of the change values to the quantity included in the change criteria to obtain other values, such as a difference between the change values and the threshold value, and/or (iii) other methods. Comparing the change values to the change criteria may also include using the change values as input to an algorithm and obtaining the outcome as output from the algorithm.

Obtaining the result may include: (i) concluding, if the outcome indicates that the change values meet the change criteria, that the dynamically generated set of changes meets the change criteria to obtain the result, (ii) concluding, if the outcome indicates that at least a portion of the change values do not meet the change criteria, that the dynamically generated set of changes does not meet the change criteria to obtain the result, (iii) providing the outcome to another entity and receiving the result in response, (iv) reading the result from storage, and/or (v) other methods.

The method may end following operation 314.

Turning to FIG. 3C, a third flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3C may be an expansion of operation 310 shown in FIG. 3B.

At operation 320, a criticality value for the dynamically generated set of changes may be obtained using the dynamically generated set of changes and the codebase. Obtaining the criticality value may include: (i) evaluating a degree of impact of integrating the dynamically generated set of changes into the codebase, the degree of impact being based on a number of APIs impacted by the dynamically generated set of changes, (ii) assigning, based on the degree of impact, the criticality value, (iii) receiving the criticality value from another entity, (iv) reading the criticality value from storage, and/or (v) other methods.

Evaluating the degree of impact of integrating the dynamically generated set of changes into the codebase may include: (i) obtaining the number of APIs impacted by the dynamically generated set of changes, (ii) obtaining, based on the number of APIs, the degree of impact, (iii) receiving the degree of impact from another entity, and/or (iv) other methods.

Obtaining the number of APIs impacted by the dynamically generated set of changes may include: (i) identifying API calls within the codebase that would be impacted by the dynamically generated set of changes, (ii) analyzing software dependencies to identify any external APIs that would be impacted by the dynamically generated set of changes, (iii) analyzing API documentation used by the software program to identify APIs likely to be impacted by the dynamically generated set of changes, (iv) reading the number of APIs from storage, (v) receiving the number of APIs from another entity, and/or (vi) other methods.

Obtaining the degree of impact based on the number of APIs may include: (i) assigning the degree of impact based on the number of APIs (e.g., if the number of APIs is 20, the degree of impact may be 20), (ii) identifying the degree of impact using a schema, rule set, table, and/or other data structure usable to obtain degrees of impact based on the number of APIs, (iii) providing the number of APIs to another entity and receiving the degree of impact in response, and/or (iv) other methods.

Assigning the criticality value based on the degree of impact may include: (i) searching a schema, rule set, table, and/or other data structure using the degree of impact as a key for the search to identify the criticality value, (ii) providing the degree of impact to another entity and receiving the criticality value in response, and/or (iii) other methods.

At operation 322, a similarity value for the dynamically generated set of changes may be obtained using the dynamically generated set of changes and the codebase. Obtaining the similarity value may include: (i) obtaining, using the dynamically generated set of changes and a trained machine learning model, a first summary of the dynamically generated set of changes and a second summary of at least a portion of the source code that would be impacted by integrating the dynamically generated set of changes into the codebase, (ii) comparing the first summary and the second summary to obtain a difference, (iii) assigning, based on the difference, the similarity value, (iv) receiving the similarity value from another entity, (v) reading the similarity value from storage, and/or (vi) other methods.

Obtaining the first summary of the dynamically generated set of changes and the second summary of the at least the portion of the source code may include: (i) feeding the dynamically generated set of changes and the at least the portion of the source code into the trained machine learning model (e.g., an LLM) as ingest, (ii) prompting the trained machine learning model to summarize the dynamically generated set of changes and the at least the portion of the source code, (iii) obtaining the first summary and the second summary as output from the trained machine learning model, (iv) providing the dynamically generated set of changes and/or the at least the portion of the source code to another entity (e.g., that hosts and/or operates the trained machine learning model) and receiving the first summary and/or the second summary in response, and/or (v) other methods.

Comparing the first summary and the second summary to obtain the difference may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain the difference, (iii) feeding the first summary and the second summary to an LLM as ingest, (iv) prompting the LLM to compare the first summary and the second summary, (v) obtaining the difference as output from the LLM, (vi) providing the first summary and the second summary to another entity responsible for comparing the first summary and the second summary and receiving the difference in response, and/or (vii) other methods.

Assigning the similarity value based on the difference may include: (i) searching a schema, rule set, table, and/or other data structure using the difference as a key for the search to identify the similarity value, (ii) providing the difference to another entity and receiving the similarity value in response, and/or (iii) other methods.

At operation 324, the change magnitude may be obtained using at least the criticality value and the similarity value. Obtaining the change magnitude may include: (i) calculating the change magnitude using the criticality value and the similarity value, (ii) providing the criticality value and the similarity value to another entity and receiving the change magnitude in response, and/or (iii) other methods.

Calculating the change magnitude may include: (i) obtaining a weighted sum of the criticality value and the similarity value and using the weighted sum as the change magnitude, (ii) using any other algorithm and/or calculation to obtain the change magnitude using the criticality value and the similarity value, and/or (iii) other methods.

The method may end following operation 324.

Thus, as illustrated above, embodiments disclosed herein may provide systems and methods usable to manage integration of sets of changes into codebases for software programs in a manner that reduces a likelihood of negatively impacting the software programs. Consequently, computer-implemented services provided using the software programs may be provided as desired by downstream consumers of the computer-implemented services.

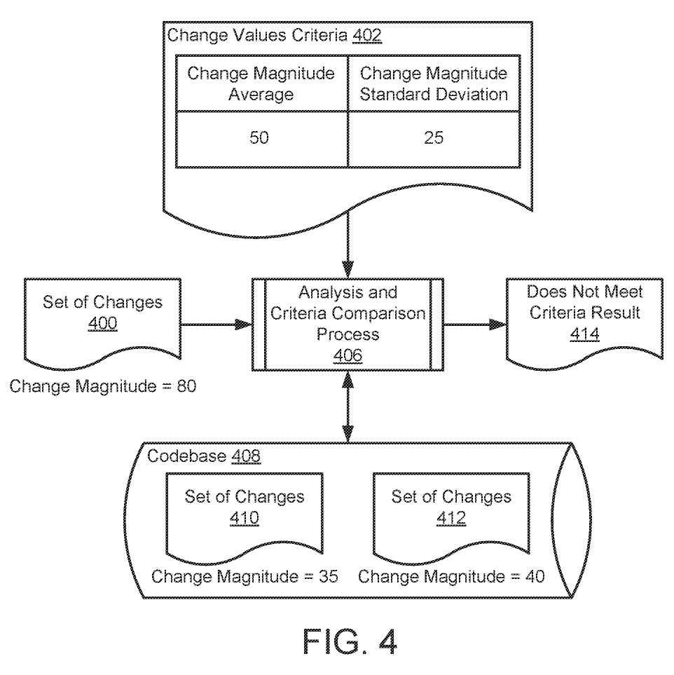

To further clarify embodiments disclosed herein, an example implementation in accordance with an embodiment is shown in FIG. 4. Turning to FIG. 4, a diagram illustrating an example of determining whether change values for evaluation of a dynamically generated set of changes (e.g., set of changes 400) meets change values criteria (e.g., change values criteria 402) using historical data for a codebase (e.g., codebase 408) is shown.

Consider a scenario in which set of changes 400 is obtained for codebase 408. A change magnitude may be obtained for set of changes 400 (e.g., using methods similar to those described in FIG. 2D). The change magnitude for set of changes 400 may be calculated to be 80 (e.g., on a scale of 1-100, where 1 indicates a lowest level of change to codebase 408, and 100 indicates a highest level of change to codebase 408).

Codebase 408 may include source code for a software program, and may also include historical data for codebase 408 (it will be appreciated that the historical data for codebase 408 may be stored in other storage devices/architectures). The historical data may include previous sets of changes for codebase 408, which may include set of changes 410 and set of changes 412. The historical data may also include corresponding change magnitudes for the previous sets of changes. For example, the change magnitudes for the previous sets of changes may include 35 and 40.

The change magnitude for set of changes 400 (e.g., 80) and the change magnitudes for the previous sets of changes (e.g., 35 and 40), may be used to perform analysis and criteria comparison process 406. During analysis and criteria comparison process 406, change values may be obtained for evaluation of set of changes 400. The change values may include a change magnitude average and a change magnitude standard deviation should set of changes 400 be integrated into codebase 408. For example, the change magnitude average may be calculated to be 51.66 and the change magnitude standard deviation may be calculated to be 20.15.

The change values may be used to evaluate set of changes 400 during analysis and criteria comparison process 406. To do so, change values criteria 402 may be used. Change values criteria 402 may include a policy obtained from a SME and/or a management entity of codebase 408. Change values criteria 402 may include two threshold values: (i) a threshold change magnitude average (e.g., 50), and (ii) a threshold change magnitude standard deviation. The thresholds, when met (e.g., the thresholds may be met if the change values exceed the corresponding threshold values), may indicate that set of changes 400 has an unacceptable level of deviation from the historical data.

In this example, the change magnitude standard deviation may not meet the corresponding threshold included in change values criteria 402 (e.g., 20.15 does not exceed the threshold value of 25). However, the change magnitude average may meet the corresponding threshold included in change values criteria 402 (e.g., 51.66 exceeds the threshold value of 50). As a result, does not meet criteria result 414 may be obtained.

Does not meet criteria result 414 may include an indication that set of changes 400 does not meet change values criteria 402. Based on does not meet criteria result 414, it may be concluded that set of changes 400 is inappropriate for integration into codebase 408, and at least one action may be identified (e.g., based on a policy) to manage integration of set of changes 400 into codebase 408. For example, set of changes 400 may be broken into two smaller sets of changes, where each of the two smaller sets of changes has a lower change magnitude than the change magnitude for set of changes 400 (e.g., lower than 80). As a result, the two smaller sets of changes may meet change values criteria 402.

Any of the components illustrated in FIGS. 1-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using a data processing system, the method comprising:
iteratively evaluating a dynamically generated set of changes for a codebase until a final set of changes meeting change criteria is obtained, the codebase comprising source code for a software program, the change criteria being adapted to discriminate whether the final set of changes is likely to introduce undesired operation of an updated version of the software program due to unintended consequences of the final set of changes, and the final set of changes comprising changes to the source code usable to obtain the updated version of the software program; and
performing, using the final set of changes, an integration process to obtain the updated version of the software program to continue provision of the computer-implemented services.

2. The method of claim 1, wherein iteratively evaluating the dynamically generated set of changes comprises:
obtaining the dynamically generated set of changes from an entity through a graphical user interface;
performing, using the dynamically generated set of changes, an analysis process to obtain a result, the result indicating whether the dynamically generated set of changes meets the change criteria; and
updating the graphical user interface to reflect at least a portion of the result.

3. The method of claim 2, wherein performing the analysis process comprises:
obtaining, using the dynamically generated set of changes, a change magnitude for the dynamically generated set of changes, the change magnitude indicating a level of change to the source code should the dynamically generated set of changes be integrated into the codebase;
obtaining, using the change magnitude and historical data for the codebase, change values for evaluation of the dynamically generated set of changes; and
making a determination, based on the change values, regarding whether the change values meet the change criteria to obtain the result.

4. The method of claim 3, wherein obtaining the change magnitude comprises:
obtaining, using the dynamically generated set of changes and the codebase, a criticality value for the set of changes;
obtaining, using the dynamically generated set of changes and the codebase, a similarity value for the dynamically generated set of changes; and
obtaining, using at least the criticality value and the similarity value, the change magnitude.

5. The method of claim 4, wherein obtaining the criticality value comprises:
evaluating a degree of impact of integrating the dynamically generated set of changes into the codebase, the degree of impact being based on a number of application programming interfaces (APIs) impacted by the dynamically generated set of changes; and
assigning, based on the degree of impact, the criticality value.

6. The method of claim 4, wherein obtaining the similarity value comprises:
obtaining, using the dynamically generated set of changes and a trained machine learning model, a first summary of the dynamically generated set of changes and a second summary of at least a portion of the source code that would be impacted by integrating the dynamically generated set of changes into the codebase;
comparing the first summary and the second summary to obtain a difference; and
assigning, based on the difference, the similarity value.

7. The method of claim 4, wherein the change magnitude is a weighted sum of the criticality value and the similarity value.

8. The method of claim 3, wherein the change values comprise a change magnitude average and a change magnitude standard deviation should the dynamically generated set of changes be integrated into the codebase.

9. The method of claim 8, wherein the historical data comprises:
previous sets of changes that have been integrated into the codebase; and
change magnitudes for the previous sets of changes.

10. The method of claim 9, wherein obtaining the change values comprises:
obtaining, using the change magnitudes for the previous sets of changes and the change magnitude for the dynamically generated set of changes, the change magnitude average; and
obtaining, using the change magnitudes for the previous sets of changes and the change magnitude for the dynamically generated set of changes, the change magnitude standard deviation.

11. The method of claim 9, wherein the change criteria comprises a threshold value for the change values, and meeting the threshold value indicates that the dynamically generated set of changes has an unacceptable level of deviation from the historical data to be integrated into the codebase.

12. The method of claim 11, wherein the unacceptable level of deviation from the historical data indicates integrating the dynamically generated set of changes into the codebase has an unacceptable risk of undesired impacts on the updated version of the software program.

13. The method of claim 2, wherein the graphical user interface is updated temporally with changes made by the entity to obtain the dynamically generated set of changes so that the entity is made aware of acceptability of the dynamically generated set of changes due to the changes made by the entity.

14. The method of claim 13, wherein the acceptability is whether the dynamically generated set of changes meets the change criteria.

15. The method of claim 14, wherein the dynamically generated set of changes is disqualified for promotion to the final set of changes until the dynamically generated set of changes meets the change criteria.

16. A non-transitory machine-readable medium having instructions stored therein, which when executed by a processor, cause the processor to perform operations for providing computer-implemented services using a data processing system, the operations comprising:
iteratively evaluating a dynamically generated set of changes for a codebase until a final set of changes meeting change criteria is obtained, the codebase comprising source code for a software program, the change criteria being adapted to discriminate whether the final set of changes is likely to introduce undesired operation of an updated version of the software program due to unintended consequences of the final set of changes, and the final set of changes comprising changes to the source code usable to obtain the updated version of the software program; and
performing, using the final set of changes, an integration process to obtain the updated version of the software program to continue provision of the computer-implemented services.

17. The non-transitory machine-readable medium of claim 16, wherein iteratively evaluating the dynamically generated set of changes comprises:
obtaining the dynamically generated set of changes from an entity through a graphical user interface;
performing, using the dynamically generated set of changes, an analysis process to obtain a result, the result indicating whether the dynamically generated set of changes meets the change criteria; and
updating the graphical user interface to reflect at least a portion of the result.

18. The non-transitory machine-readable medium of claim 17, wherein performing the analysis process comprises:
obtaining, using the dynamically generated set of changes, a change magnitude for the dynamically generated set of changes, the change magnitude indicating a level of change to the source code should the dynamically generated set of changes be integrated into the codebase;
obtaining, using the change magnitude and historical data for the codebase, change values for evaluation of the dynamically generated set of changes; and
making a determination, based on the change values, regarding whether the change values meet the change criteria to obtain the result.

19. A data processing system, comprising:
a processor; and
a memory coupled to the processor to store instructions, which when executed by the processor, cause the processor to perform operations for providing computer-implemented services using a data processing system, the operations comprising:
iteratively evaluating a dynamically generated set of changes for a codebase until a final set of changes meeting change criteria is obtained, the codebase comprising source code for a software program, the change criteria being adapted to discriminate whether the final set of changes is likely to introduce undesired operation of an updated version of the software program due to unintended consequences of the final set of changes, and the final set of changes comprising changes to the source code usable to obtain the updated version of the software program; and
performing, using the final set of changes, an integration process to obtain the updated version of the software program to continue provision of the computer-implemented services.

20. The data processing system of claim 19, wherein iteratively evaluating the dynamically generated set of changes comprises:
obtaining the dynamically generated set of changes from an entity through a graphical user interface;
performing, using the dynamically generated set of changes, an analysis process to obtain a result, the result indicating whether the dynamically generated set of changes meets the change criteria; and
updating the graphical user interface to reflect at least a portion of the result.
